(19) United States
(12) Patent Application Publication
(10) Pub. No.: US 2026/0149154 A1
(43) Pub. Date: May 28, 2026

(54) CASE FOR SECONDARY BATTERY, SECONDARY BATTERY, AND METHOD FOR MANUFACTURING THE SAME

(71) Applicant: SAMSUNG SDI CO., LTD., Yongin-si (KR)

(72) Inventors: Jeawoan LEE, Yongin-si (KR); Won-Seok KIM, Yongin-si (KR); Soo-Mi EO, Yongin-si (KR)

(21) Appl. No.: 19/391,850

(22) Filed: Nov. 17, 2025

(30) Foreign Application Priority Data
Nov. 22, 2024 (KR) 10-2024-0168524

(51) Int. Cl. H01M 50/645; H01M 10/04; H01M 50/103; H01M 50/119; H01M 50/133; H01M 50/14; H01M 50/15; H01M 50/169; H01M 50/564

(52) U.S. Cl. CPC H01M 50/645; H01M 10/049; H01M 50/103; H01M 50/119; H01M 50/133; H01M 50/14; H01M 50/15; H01M 50/169; H01M 50/564

(57) ABSTRACT

The present disclosure provides a case for a secondary battery. The case for a secondary battery includes a can that includes a receiving part including a first injection hole and a first terminal hole in a first side of the receiving part and a flange part around a second side of the receiving part, a reinforcing plate joined with the first side of the receiving part, wherein the reinforcing plate includes a second injection hole corresponding to the first injection hole and a second terminal hole corresponding to the first terminal hole and a cover joined with the flange part to seal the second side of the receiving part.

### CROSS-REFERENCE TO RELATED APPLICATION

The present application claims priority to and the benefit of Korean Patent Application No. 10-2024-0168524, filed in the Korean Intellectual Property Office on Nov. 22, 2024, the entire disclosure of which is hereby incorporated by reference.

### BACKGROUND

### 1. Field

Aspects of embodiments of the present disclosure relate to a case for a secondary battery, a secondary battery, and a method for manufacturing the same.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

An aluminum alloy may be used for a case of a secondary battery used in small electronic devices for purposes of providing light weight, moldability, and economy, but may be damaged due to complex reasons during various processes. To minimize the damage, a technology that uses material other than aluminum (Al) for the secondary battery can, such as stainless use steel (SUS) can, has been studied.

A secondary battery having high energy density (for example, an amount of energy to be storable per unit volume) may provide longer runtime or longer mileage in portable devices or electric vehicles. In some embodiments, the energy density of the secondary battery may be a factor which determines performance of the secondary battery.

One method for enhancing the energy density of a secondary battery is to manufacture a case with a thin thickness. However, as the thickness of the case decreases, pressure may be locally applied to the case in an injection process, a molding process, or the like. For example, an injection port of the case may be deformed due to sealing pressure of an injector in the injection process, fastening pressure of a charge and discharge device, and the like.

The above information disclosed in this Background section is for enhancement of understanding of the background of the present disclosure, and therefore, it may contain information that does not constitute related (or prior) art.

### SUMMARY

One or more embodiments of the present disclosure are directed to a case for a secondary battery, a secondary battery, and a method for manufacturing the same.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

Aspects of embodiments of the present disclosure provide a case for a secondary battery including a can that includes a receiving part including a first injection hole and a first terminal hole in a first side of the receiving part and a flange part around a second side of the receiving part, a reinforcing plate joined with the first side of the receiving part, wherein the reinforcing plate includes a second injection hole corresponding to the first injection hole and a second terminal hole corresponding to the first terminal hole and a cover joined with the flange part to seal the second side of the receiving part.

According to one embodiment, the reinforcing plate may be formed to have a length corresponding to a length of the first side of the receiving part.

According to one embodiment, the reinforcing plate may be formed to have a length larger than a distance between the first injection hole and the first terminal hole.

According to one embodiment, the reinforcing plate may be joined with an outer surface of the receiving part.

According to one embodiment, the reinforcing plate may be joined with an inner surface of the receiving part.

According to one embodiment, the reinforcing plate includes a first reinforcing plate joined with an outer surface of the receiving part and a second reinforcing plate joined with an inner surface of the receiving part.

According to one embodiment, the reinforcing plate may be formed of a same material as the receiving part.

According to one embodiment, at least one of the receiving part or the reinforcing plate includes stainless use steel (SUS).

According to one embodiment, a thickness of the reinforcing plate may be in a range from approximately 0.05 mm to approximately 0.1 mm.

According to one embodiment, a thickness of the first side of the receiving part with which the reinforcing plate is joined may be in a range from approximately 0.08 mm to approximately 0.13 mm.

According to one embodiment, at least a portion of the cover and the flange part may be joined through laser welding.

Aspects of embodiments provide a secondary battery including an electrode assembly includes a first electrode, a separator, and a second electrode, a can for accommodating the electrode assembly, wherein the can includes a first side having a first injection hole and a first terminal hole, a reinforcing plate joined with the first side of the can, wherein the reinforcing plate includes a second injection hole corresponding to the first injection hole and a second terminal hole corresponding to the first terminal hole, and a cover configured to seal a second side of the can.

According to one embodiment, the reinforcing plate includes a first reinforcing plate joined with an outer surface of the can and a second reinforcing plate joined with an inner surface of the can.

According to one embodiment, may further include an injection pin joined with the can via the first injection hole and the second injection hole, wherein the injection pin seals the first injection hole and the second injection hole.

According to one embodiment, may further include an electrode terminal electrically coupled to one of the first electrode or the second electrode, and joined with the can via the first terminal hole and the second terminal hole.

Aspects of embodiments provide a method for manufacturing a secondary battery including preparing a can that includes a receiving part which accommodates an electrode assembly and a flange part surrounding an opened first side of the receiving part, joining a reinforcing plate with a first side of the receiving part, forming a first injection hole and a second injection hole by punching the receiving part with which the reinforcing plate is joined, forming a first terminal hole and a second terminal hole by punching the receiving part with which the reinforcing plate is joined, and joining a cover with the flange part.

According to one embodiment, the joining of the reinforcing plate with the first side of the receiving part includes joining the reinforcing plate with an outer surface of the first side of the receiving part.

According to one embodiment, the joining of the reinforcing plate with the first side of the receiving part includes joining the reinforcing plate with an inner surface of the first side of the receiving part.

According to one embodiment, joining of the reinforcing plate with the first side of the receiving part includes joining a first reinforcing plate and a second reinforcing plate with an inner surface and an outer surface of the first side of the receiving part, respectively.

According to one embodiment, after the joining of the cover with the flange part, injecting an electrolyte into an inner space of the can by inserting an electrolyte injector into the first injection hole and the second injection hole.

According to some embodiments of the present disclosure, the capacity may be improved by molding a prismatic secondary battery with a thin metal and an outer appearance defect of the secondary battery may be prevented or reduced when the pressure is locally applied in an injection process, a molding process, or the like.

According to some embodiments of the present disclosure, by joining a reinforcing plate with a portion for an electrolyte injection port formed on the case of the secondary battery, the injection port portion of the case may be less susceptible to being deformed due to external factors, such as, for example, sealing pressure of an injector, fastening pressure of a charge and discharge device, and the like, in an injection process and a molding process of the secondary battery and the like.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is an exploded perspective view illustrating an example case for a secondary battery according to some embodiments of the present disclosure.

FIG. 2 is a perspective view illustrating an example case for a secondary battery according to some embodiments of the present disclosure.

FIG. 3 is a diagram illustrating an example reinforcing plate according to some embodiments of the present disclosure.

FIG. 4 is a diagram illustrating a case of a secondary battery in which a reinforcing plate is arranged in an outer surface of a receiving part according to some embodiments of the present disclosure.

FIG. 5 is a diagram illustrating the case of FIG. 4 in which the reinforcing plate is joined with the outer surface of the receiving part according to some embodiments of the present disclosure.

FIG. 6 is a diagram illustrating a case of a secondary battery in which a reinforcing plate is disposed or arranged in an inner surface of a receiving part according to some embodiments of the present disclosure.

FIG. 7 is a diagram illustrating the case of FIG. 6 in which the reinforcing plate is joined with the inner surface of the receiving part according to some embodiments of the present disclosure.

FIG. 8 is a diagram illustrating a case of a secondary battery in which a reinforcing plate is arranged in an outer surface and an inner surface of a receiving part according to some embodiments of the present disclosure.

FIG. 9 is a diagram illustrating the case of FIG. 8 in which the reinforcing plate is joined with the outer surface and the inner surface of the receiving part according to some embodiments of the present disclosure.

FIG. 10 is a diagram illustrating a reinforcing plate joined with an outer surface of a receiving part according to some embodiments of the present disclosure.

FIG. 11 is a diagram illustrating a reinforcing plate joined with an inner surface of a receiving part according to some embodiments of the present disclosure.

FIG. 12 is an exploded perspective view illustrating an example secondary battery according to some embodiments of the present disclosure.

FIG. 13 is a diagram illustrating an electrolyte injector injecting an electrolyte into a secondary battery according to some embodiments of the present disclosure.

FIG. 14 is a cross-sectional view illustrating a secondary battery in which an injection pin and an electrode terminal are joined according to some embodiments of the present disclosure.

FIG. 15 is a flowchart illustrating a method for manufacturing a secondary battery according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the specification, the singular expressions are intended to include the plural expressions as well, unless the context clearly indicates otherwise. Further, the plural expressions are intended to include the singular expressions as well, unless the context clearly indicates otherwise. It will be further understood that the sentence “when a certain part includes a certain component” throughout the specification means that other components are not excluded but may be further included, unless the context clearly specifies otherwise.

In the present disclosure, dimensions and relative dimensions of layers and regions illustrated in drawings may be exaggerated for clarity of explanation. That is, the dimensions illustrated in drawings are only for convenience of understanding and are not limited thereto. Further, the same reference numerals throughout the specification designate the same elements.

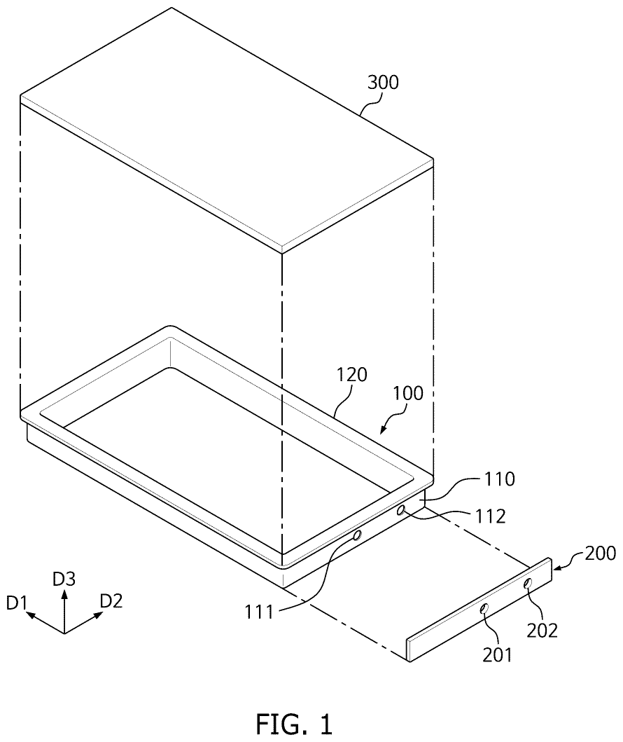

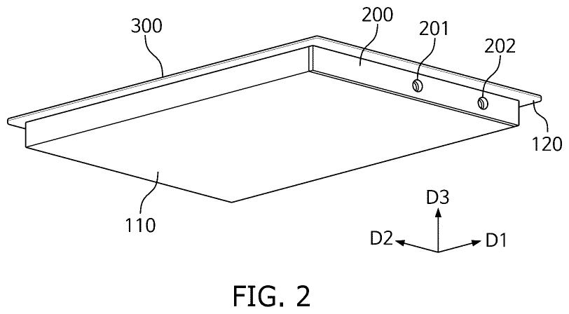

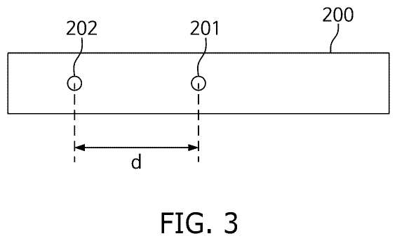

FIG. 1 is an exploded perspective view illustrating an example case for a secondary battery according to some embodiments of the present disclosure. FIG. 2 is a perspective view illustrating an example case for a secondary battery according to some embodiments of the present disclosure. and FIG. 3 is a diagram illustrating an example of a reinforcing plate according to some embodiments of the present disclosure.

Referring to FIGS. 1 to 3, a case (also referred to as a can) 100 for a secondary battery may include a receiving part 110 and a flange part 120. A first injection hole 111 and a first terminal hole 112 may be formed in a first side of the receiving part 110, for example, in one side of the can 100 in a D1 direction. The flange part 120 may be formed around (e.g., to surround) an opened second side of the receiving part 110, for example, one side of the can 100 in a D3 direction.

A receiving space which accommodates an electrode assembly of the secondary battery may be formed in the receiving part 110. A negative terminal and a positive terminal of the secondary battery may be disposed or arranged in the first side of the receiving part 110.

In some embodiments, the receiving part 110 may include the first injection hole 111. For example, the first injection hole 111 may be a through hole formed in the first side of the receiving part 110. The first injection hole 111 may be formed to inject an electrolyte into an inside of the receiving part 110 after the can 100 is joined with a cover 300 to be sealed. The first injection hole 111 may be processed to be sealed with an injection pin after the electrolyte is injected. In the illustrated embodiment, the first injection hole 111 is positioned in a center of the first side of the receiving part 110, but the present disclosure is not limited thereto and may have various modifications.

In some embodiments, the first terminal hole 112 may be formed in the first side of the receiving part 110 adjacent to the first injection hole 111. For example, the first terminal hole 112 may be a through hole formed in the first side of the receiving part 110.

In some embodiments, the receiving space in which the electrode assembly is accommodated may be formed substantially in a center region of the receiving part 110 through a pressing process and the like. Further, the flange part 120 may be formed in an upper edge of the receiving part 110 in four directions.

The reinforcing plate 200 may be joined with the first side of the receiving part 110. A second injection hole 201 corresponding to the first injection hole 111 and a second terminal hole 202 corresponding to the first terminal hole 112 may be formed in the reinforcing plate 200. For example, as illustrated in FIG. 1, the reinforcing plate 200 may be joined with the first side of the receiving part 110 in the D1 direction.

In some embodiments, the reinforcing plate 200 may be formed to have a length corresponding to a length of the first side of the receiving part 110. In some embodiments, the reinforcing plate 200 may be formed larger than a distance d between the first injection hole 111 and the first terminal hole 112.

For example, in a joined state with the first side of the receiving part 110, the reinforcing plate 200 may be configured to reinforce rigidity of the first side of the receiving part 110 when an electrolyte injector is inserted into the first injection hole 111 and the second injection hole 201 and injects the electrolyte into the inside of the receiving part 110. Further, the reinforcing plate 200 may be configured to reinforce the rigidity of the first side of the receiving part 110 with respect to fastening pressure of a charge and discharge device in a molding process. For example, the reinforcing plate 200 may be formed larger than the distance d between the first injection hole 111 and the first terminal hole 112 to complement the rigidity of the first side of the receiving part 110.

The reinforcing plate 200 may be formed of the same material as the receiving part 110. For example, at least one of the receiving part 110 and the reinforcing plate 200 may include stainless use steel (SUS). In another example, at least one of the receiving part 110 and the reinforcing plate 200 may include aluminum (Al). The reinforcing plate 200 and the receiving part 110 may be formed of a conductive metal such as aluminum, an aluminum alloy, or nickel-plated steel.

In some embodiments, the cover 300 may be configured to be joined with the flange part 120 and to seal the second side of the receiving part 110, for example, the one side of the can 100 in the D3 direction. The cover 300 may be joined with the opened second side of the can 100. In some embodiments, the can 100 and the cover 300 may be joined to form an outer appearance of the secondary battery. For example, the cover 300 may be configured as a flat plate disposed or arranged in an upper side of the can 100 to seal the receiving space of the can 100. The cover 300 may be formed as a flat plate having a size sufficient to cover the flange part 120 and may be in surface contact with the flange part 120.

The can 100 and the cover 300 may be metal-joined, for example, through welding, brazing, soldering, and the like. In some embodiments, at least a portion of the cover 300 and the flange part 120 may be joined through laser welding. For example, the flange part 120 of the can 100 and an edge portion of the cover 300 may be joined with each other. After the can 100 and the cover 300 are joined, at least a portion of the flange part 120 may be cut using laser so as to enhance the energy density of the secondary battery.

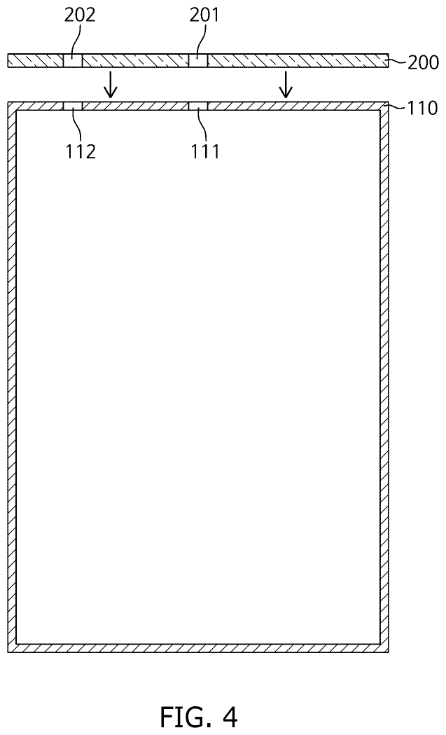

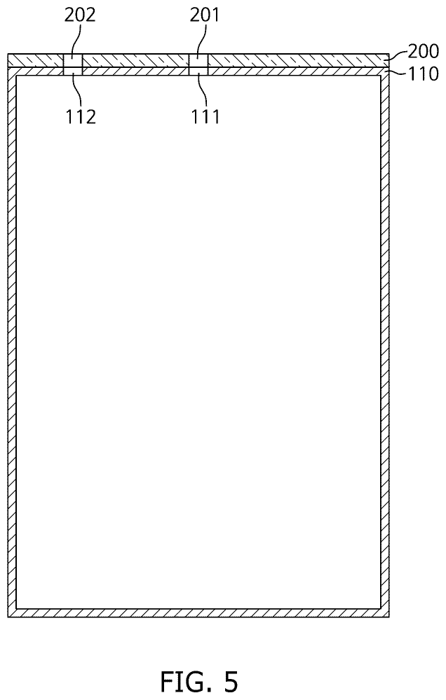

FIG. 4 is a diagram illustrating a case of a secondary battery in which a reinforcing plate is disposed or arranged in an outer surface of a receiving part according to some embodiments of the present disclosure. FIG. 5 is a diagram illustrating the case of FIG. 4 in which the reinforcing plate is joined with the outer surface of the receiving part according to some embodiments of the present disclosure.

According to some embodiments, the reinforcing plate 200 may be joined with the outer surface of the receiving part 110. For example, the reinforcing plate 200 may be formed to have a length corresponding to the first side of the receiving part 110 and may be joined with the outer surface of the receiving part 110.

In a state that the reinforcing plate 200 is joined with the outer surface of the receiving part 110, the first injection hole 111 and the second injection hole 201 may be disposed or arranged in positions corresponding to each other. In some embodiments, when the electrolyte injector is inserted into the first injection hole 111 and the second injection hole 201 and injects the electrolyte into the inside of the receiving part 110, the reinforcing plate 200 may reinforce the rigidity of the first side of the receiving part 110 so as to prevent the first injection hole 111 of the receiving part 110 from being deformed or damaged.

In the state that the reinforcing plate 200 is joined with the outer surface of the receiving part 110, the first terminal hole 112 and the second terminal hole 202 may be disposed or arranged in positions corresponding to each other. In some embodiments, the reinforcing plate 200 may be configured to reinforce the rigidity of the first side of the receiving part 110 with respect to the fastening pressure of the charge and discharge device in the molding process.

In some embodiments, a thickness of the reinforcing plate 200 may be in a range from approximately 0.05 mm to approximately 0.1 mm, and a thickness of the receiving part 110 may be in a range from approximately 0.03 mm to approximately 0.08 mm. In some embodiments, the thickness of the first side of the receiving part 110 with which the reinforcing plate 200 is joined may be in a range from approximately 0.08 mm to approximately 0.13 mm.

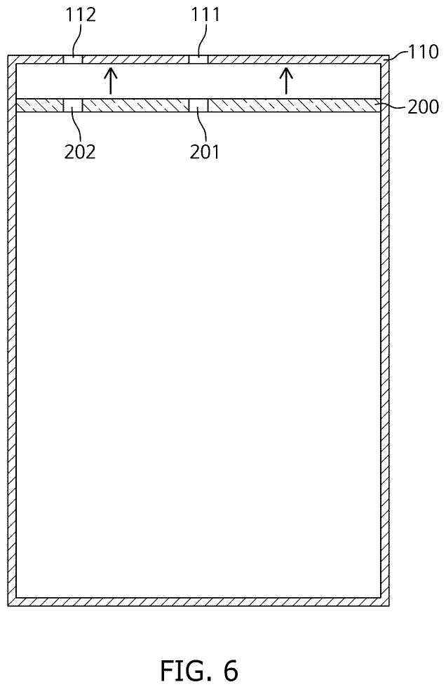

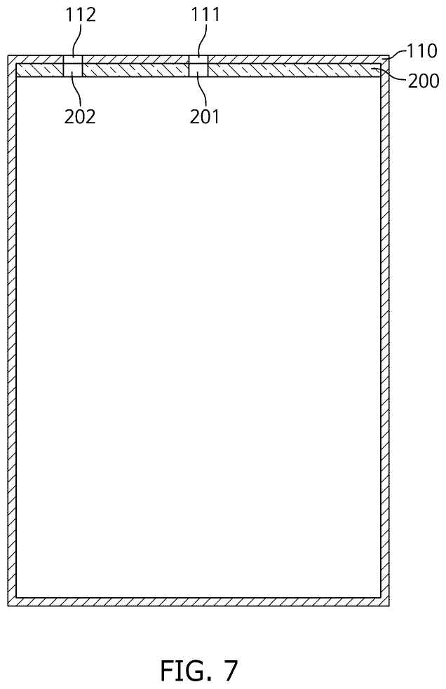

FIG. 6 is a diagram illustrating a case of a secondary battery in which a reinforcing plate is disposed or arranged in an inner surface of a receiving part according to some embodiments of the present disclosure. FIG. 7 is a diagram illustrating the case of FIG. 6 in which the reinforcing plate is joined with the inner surface of the receiving part according to some embodiments of the present disclosure.

According to some embodiments, the reinforcing plate 200 may be joined with the inner surface of the receiving part 110. For example, the reinforcing plate 200 may be formed to have a length corresponding to the first side of an inner side of the receiving part 110 and may be joined with the inner surface of the receiving part 110.

In a state that the reinforcing plate 200 is joined with the inner surface of the receiving part 110, the first injection hole 111 and the second injection hole 201 may be disposed or arranged in positions corresponding to each other. When the electrolyte injector is inserted into the first injection hole 111 and the second injection hole 201 and injects the electrolyte into the inside of the receiving part 110, the reinforcing plate 200 may reinforce the rigidity of the first side of the receiving part 110 so as to prevent the first injection hole 111 of the receiving part 110 from being deformed or damaged.

In the state that the reinforcing plate 200 is joined with the inner surface of the receiving part 110, the first terminal hole 112 and the second terminal hole 202 may be disposed or arranged in positions corresponding to each other. In some embodiments, the reinforcing plate 200 may be configured to reinforce the rigidity of the first side of the receiving part 110 with respect to the fastening pressure of the charge and discharge device in the molding process.

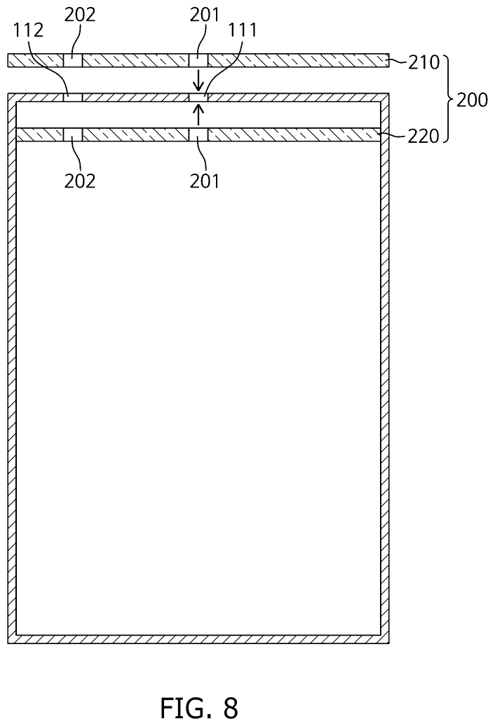

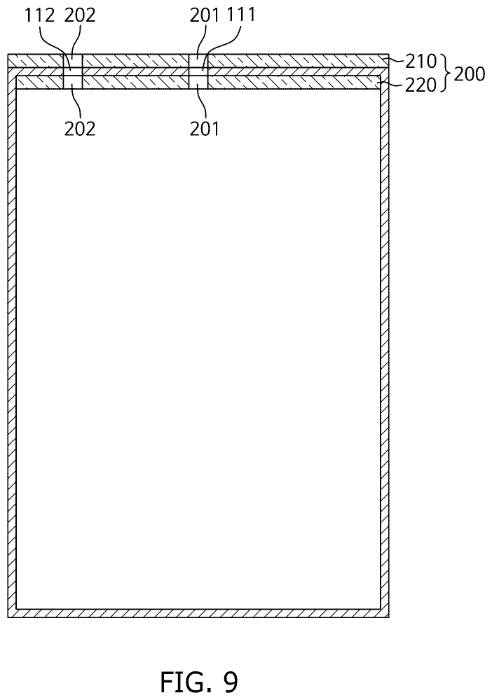

FIG. 8 is a diagram illustrating a case of a secondary battery in which a reinforcing plate is disposed or arranged in an outer surface and an inner surface of a receiving part according to some embodiments of the present disclosure. FIG. 9 is a diagram illustrating the case of FIG. 8 in which the reinforcing plate is joined with the outer surface and the inner surface of the receiving part according to some embodiments of the present disclosure.

In some embodiments, the reinforcing plate 200 may include a first reinforcing plate 210 and a second reinforcing plate 220. The first reinforcing plate 210 may be joined with the outer surface of the receiving part 110. For example, the first reinforcing plate 210 may be formed to have a length corresponding to the first side of the receiving part 110 and may be joined with the outer surface of the receiving part 110. The second reinforcing plate 220 may be joined with the inner surface of the receiving part 110. For example, the second reinforcing plate 220 may be formed to have a length corresponding to the first side of the inner side of the receiving part 110 and may be joined with the inner surface of the receiving part 110.

In a state that the first reinforcing plate 210 is joined with the outer surface of the receiving part 110 and the second reinforcing plate 220 is joined with the inner surface of the receiving part 110, the first injection hole 111 and the second injection hole 201 of each of the first reinforcing plate 210 and the second reinforcing plate 220 may be disposed or arranged in positions corresponding to each other. In some embodiments, when the electrolyte injector is inserted into the first injection hole 111 and the second injection holes 201 and injects the electrolyte into the inside of the receiving part 110, the reinforcing plate 200 may reinforce the rigidity of the first side of the receiving part 110 so as to prevent the first injection hole 111 of the receiving part 110 from being deformed or damaged or reduce such a deformation of the receiving part.

In the state that the first reinforcing plate 210 is joined with the outer surface of the receiving part 110 and the second reinforcing plate 220 is joined with the inner surface of the receiving part 110, the first terminal hole 112 and the second terminal hole 202 of each of the first reinforcing plate 210 and the second reinforcing plate 220 may be disposed or arranged in positions corresponding to each other. In some embodiments, the reinforcing plate 200 may be configured to reinforce the rigidity of the first side of the receiving part 110 with respect to the fastening pressure of the charge and discharge device in the molding process.

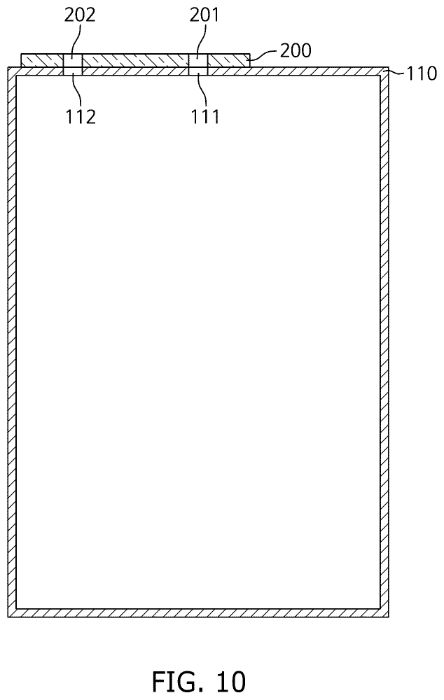

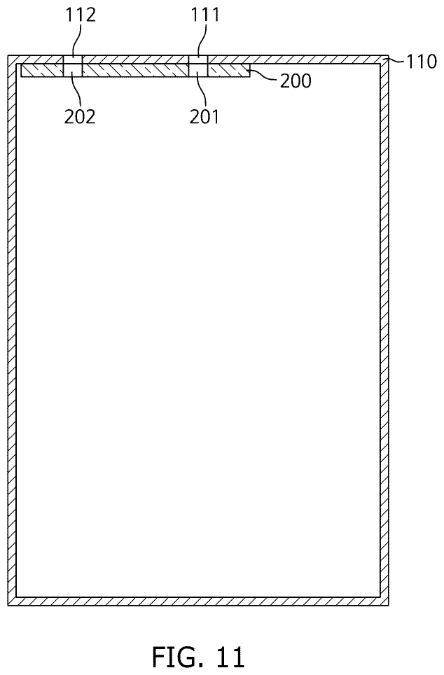

FIG. 10 is a diagram illustrating a reinforcing plate joined with an outer surface of a receiving part according to some embodiments of the present disclosure. FIG. 11 is a diagram illustrating a reinforcing plate joined with an inner surface of a receiving part according to some embodiments of the present disclosure.

In some embodiments, a length of the reinforcing plate 200 may be larger or greater than the distance between the first injection hole 111 and the first terminal hole 112 formed in the first side of the receiving part 110. In some embodiments, the reinforcing plate 200 may be formed to have the length smaller than the length of the first side of the receiving part 110. For example, as illustrated in FIG. 10, the reinforcing plate 200 may be joined with the outer surface of the receiving part 110 so that the first injection hole 111 and the first terminal hole 201 may correspond to the second injection hole 112 and the second terminal hole 202, respectively. In another example, as illustrated in FIG. 11, the reinforcing plate 200 may be joined with the inner surface of the receiving part 110 so that the first injection hole 111 and the first terminal hole 201 may correspond to the second injection hole 112 and the second terminal hole 202, respectively.

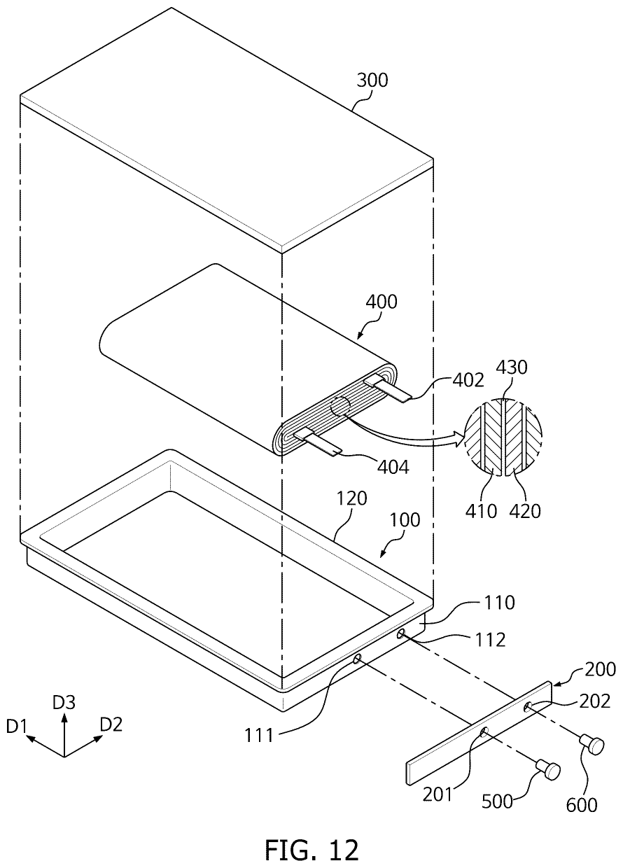

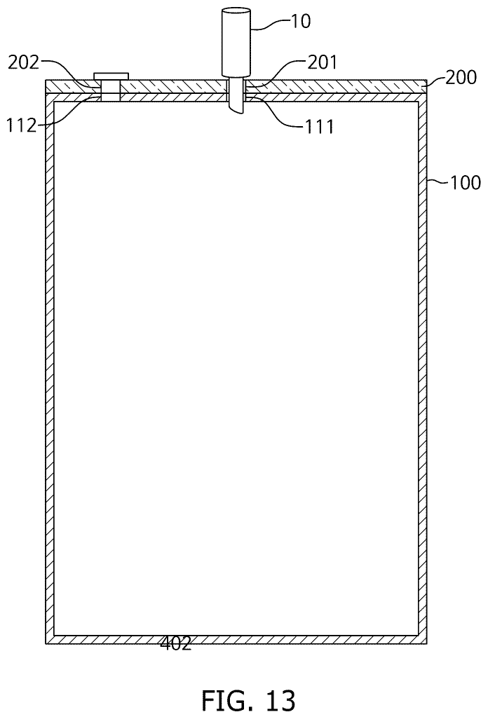

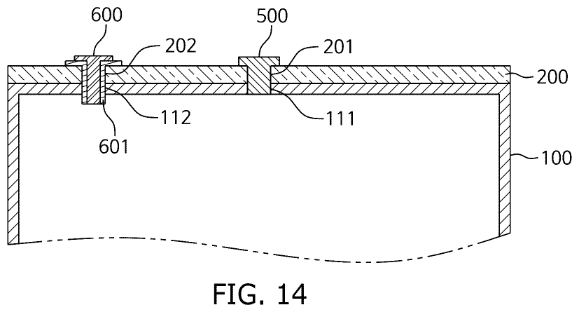

FIG. 12 is an exploded perspective view illustrating an example secondary battery according to some embodiments of the present disclosure FIG. 13 is a diagram illustrating an electrolyte injector injecting an electrolyte into a secondary battery according to some embodiments of the present disclosure. FIG. 14 is a cross-sectional view illustrating a secondary battery in which an injection pin and an electrode terminal are joined according to some embodiments of the present disclosure.

Referring to FIGS. 12 to 14, the secondary battery may include an electrode assembly 400 including a first electrode 410, a separator 430, and a second electrode 420, a can 100 which accommodates the electrode assembly 400 and a first injection hole 111 and a first terminal hole 112 are formed in a first side thereof, for example, in one side of the can 100 in a D1 direction, a reinforcing plate 200 which is joined with a first side of the can 100 and a second injection hole 201 corresponding to the first injection hole 111 and a second terminal hole 202 corresponding to the first terminal hole 112 are formed therein, and a cover 300 configured to seal an opened second side of the can 100, for example, one side of the can 100 in a D3 direction.

For example, the electrode assembly 400 may be formed in such a manner that the first electrode 410 and the second electrode 420 are wound or stacked with the separator 430 as an insulator interposed therebetween. The first electrode 410 may include a first base material and a first active material layer disposed or arranged in the first base material. A first electrode tab 402 may extend outwardly from a first uncoated portion of the first base material on which the first active material layer is not positioned. The second electrode 420 may include a second base material and a second active material layer positioned in the second base material. A second electrode tab 404 may extend outwardly from a second uncoated portion of the second base material on which the second active material layer is not positioned.

The first electrode 410 may serve as a positive electrode. For example, the first base material may be a positive electrode base material. For example, the positive electrode base material may be configured of an aluminum foil, and the positive electrode active material layer may include a transition metal oxide.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3-f) Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

The second electrode 420 may serve as a negative electrode. For example, the second base material may include a negative electrode base material. In this example, the negative electrode base material may be configured of a copper foil or a nickel foil, and the negative electrode active material layer may include graphite.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The separator 430 may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator 430 may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and a combination thereof, but is not limited thereto.

The organic material and the inorganic material may be mixed in one coating layer, or a coating layer including an organic material and a coating layer including an inorganic material may be stacked.

In some embodiments, at least one of the can 100 and the cover 300 may include stainless use steel (SUS). For example, the can 100 and the cover 300 illustrated in FIG. 1 may include stainless use steel (SUS), and thus the secondary battery may be a SUS can type secondary battery, but the present disclosure is not limited thereto. In another example, the can 100 and the cover 300 may be formed of a conductive metal such as aluminum, an aluminum alloy, or nickel-plated steel to form an entire outer appearance of the secondary battery. In some embodiments, the secondary battery may be a lithium battery cell, a sodium battery cell, and the like. However, the present disclosure is not limited thereto, and the secondary battery may include any battery which may provide electricity repeatedly through charging and discharging.

In some embodiments, the first injection hole 111 and the first terminal hole 112 may be formed in the first side of the can 100. For example, the first injection hole 111 and the first terminal hole 112 may be disposed or arranged to be spaced apart at a certain interval in the first side of the can 100.

The secondary battery may further include an injection pin 500 which passes through the first injection hole 111 and the second injection hole 201 to be joined with the can 100, and seals the first injection hole 111 and the second injection hole 201. For example, the injection pin 500 may be formed to include a body which is pressed in the first injection hole 111 and the second injection hole 201 and a head which seals outer sides of the first injection hole 111 and the second injection hole 201. The injection pin 500 may be formed so that a horizontal cross section of an upper head may have any one shape selected from a circular shape and a quadrangular shape, but the shape of the injection pin 500 in the present disclosure is not limited thereto.

As illustrated in FIG. 13, when the electrolyte is injected into the inside of the secondary battery through an electrolyte injector 10, the reinforcing plate 200 may prevent the first injection hole 111 from being deformed or damaged due to pressure of the electrolyte injector 10, or may reduce such a deformation or damage of the first injection hole.

In some embodiments, the secondary battery may further include an electrode terminal 600 which is electrically coupled to any one of the first electrode 410 and the second electrode 420 and passes through the first terminal hole 112 and the second terminal hole 202 to be joined with the can 100. The electrode terminal 600 may be a positive electrode terminal and may be electrically coupled to the first electrode tab 402 of the electrode assembly 400.

Positions of the injection pin 500 and the electrode terminal 600 according to the present disclosure are not limited to the positions illustrated in FIG. 12 and may have various modifications.

In some embodiments, the electrode terminal 600 may pass through the first terminal hole 112 and the second terminal hole 202 to be inserted thereinto and may be electrically coupled to the first electrode tab 402 of the electrode assembly through a terminal plate in an inside of the can 100. For example, the electrode terminal 600 may be electrically insulated from the can 100 by a gasket 601.

A horizontal cross section of an upper head of the electrode terminal 600 may be formed in any one shape selected from a circular shape and a quadrangular shape, but the shape of the electrode terminal 600 in the present disclosure is not limited thereto. In some embodiments, the electrode terminal 600 may be assembled to the first terminal hole 112 and the second terminal hole 202 through a spinning method.

For example, the electrode terminal 600 may be joined with the terminal plate coupled to the first electrode 410 of the electrode assembly 400 and may be electrically coupled to an external terminal. The gasket 601 may be disposed or arranged between the electrode terminal 600 and the can 100. The electrode terminal 600 may pass through the gasket 601 to be joined with the terminal plate. In some embodiments, the gasket 601 may be disposed or arranged between the can 100 and the electrode terminal 600 in an outer side of the can 100. The gasket 601 may be inserted into the first terminal hole 112 and the second terminal hole 202. For example, an upper surface of the electrode terminal 600 may be placed in a head portion forming an upper surface of the gasket 601. A body portion forming a lower surface of the gasket 601 may be formed around (e.g., to surround) the electrode terminal 600 and may be inserted into the first terminal hole 112 and the second terminal hole 202 together with the electrode terminal 600. The gasket 601 may be formed to surround the electrode terminal 600 to electrically insulate the electrode terminal 600 and the can 100. The gasket 601 may include an insulating material to electrically insulate the electrode terminal 600 from the can 100.

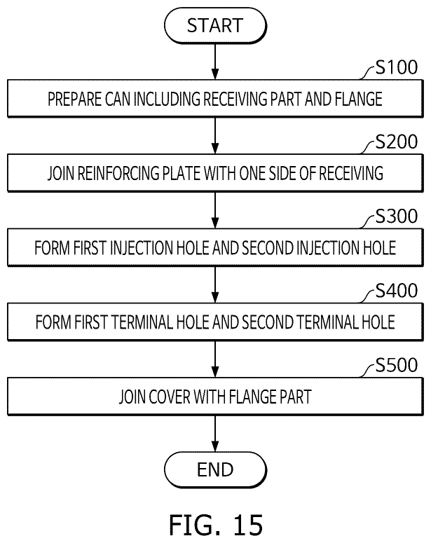

FIG. 15 is a flowchart illustrating a method for manufacturing a secondary battery according to some embodiments of the present disclosure.

Referring to FIG. 15, the method for manufacturing a secondary battery may include an operation of preparing a can including a receiving part and a flange part (S100), an operation of joining a reinforcing plate with one side of the receiving part (S200), an operation of forming a first injection hole and a second injection hole (S300), an operation of forming a first terminal hole and a second terminal hole (S400), and an operation of joining the cover with the flange part (S500).

In some embodiments, the operation S100 of preparing the can including the receiving part and the flange part may include an operation of preparing the can including the receiving part which accommodates an electrode assembly and the flange part surrounding an opened first side of the receiving part.

After the operation S100 of preparing the can, the operation S200 of joining the reinforcing plate may be performed. The operation S200 of joining the reinforcing plate with the one side of the receiving part may include an operation of joining the reinforcing plate with the first of the receiving part.

In some embodiments, the operation S200 of joining the reinforcing plate with the first side of the receiving part may include an operation of joining the reinforcing plate with an outer surface of the first side of the receiving part. In some embodiments, the operation S200 of joining the reinforcing plate with the first side of the receiving part may include an operation of joining the reinforcing plate with an inner surface of the first side of the receiving part. In some embodiments, the operation S200 of joining the reinforcing plate with the first side of the receiving part may include an operation of joining a first reinforcing plate and a second reinforcing plate with the inner surface and the outer surface of the first side of the receiving part, respectively.

In some embodiments, the operation S300 of forming the first injection hole and the second injection hole may include an operation of forming the first injection hole and the second injection hole by punching the receiving part with which the reinforcing plate is joined. Similarly, the operation S400 of forming the first terminal hole and the second terminal hole may include an operation of forming the first terminal hole and the second terminal hole by punching the receiving part with which the reinforcing plate is joined.

In some embodiments, in the operation S500 of joining the cover with the flange part, the cover and the flange part may be metal-joined, for example, through welding, brazing, soldering, and the like. In some embodiments, at least a portion of the cover and the flange part may be joined through laser welding. For example, the flange part and an edge portion of the cover may be joined.

In some embodiments, after the operation S500 of joining the cover with the flange part, an operation of injecting an electrolyte into an inner space of the can by inserting an electrolyte injector into the first injection hole and the second injection hole may be further performed.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. A case for a secondary battery comprising:
a can comprising a receiving part including a first injection hole and a first terminal hole in a first side of the receiving part and a flange part around a second side of the receiving part;
a reinforcing plate joined with the first side of the receiving part, wherein the reinforcing plate includes a second injection hole corresponding to the first injection hole and a second terminal hole corresponding to the first terminal hole; and
a cover joined with the flange part to seal the second side of the receiving part.

2. The case for a secondary battery as claimed in claim 1, wherein the reinforcing plate is formed to have a length corresponding to a length of the first side of the receiving part.

3. The case for a secondary battery as claimed in claim 1, wherein the reinforcing plate is formed to have a length larger than a distance between the first injection hole and the first terminal hole.

4. The case for a secondary battery as claimed in claim 1, wherein the reinforcing plate is joined with an outer surface of the receiving part.

5. The case for a secondary battery as claimed in claim 1, wherein the reinforcing plate is joined with an inner surface of the receiving part.

6. The case for a secondary battery as claimed in claim 1, wherein the reinforcing plate comprises:
a first reinforcing plate joined with an outer surface of the receiving part; and
a second reinforcing plate joined with an inner surface of the receiving part.

7. The case for a secondary battery as claimed in claim 1, wherein the reinforcing plate is formed of a same material as the receiving part.

8. The case for a secondary battery as claimed in claim 1, wherein at least one of the receiving part or the reinforcing plate comprises stainless use steel (SUS).

9. The case for a secondary battery as claimed in claim 1, wherein a thickness of the reinforcing plate is in a range from approximately 0.05 mm to approximately 0.1 mm.

10. The case for a secondary battery as claimed in claim 1, wherein a thickness of the first side of the receiving part with which the reinforcing plate is joined is in a range from approximately 0.08 mm to approximately 0.13 mm.

11. The case for a secondary battery as claimed in claim 1, wherein at least a portion of the cover and the flange part are joined through laser welding.

12. A secondary battery comprising:
an electrode assembly comprising a first electrode, a separator, and a second electrode;
a can for accommodating the electrode assembly, wherein the can includes a first side having a first injection hole and a first terminal hole;
a reinforcing plate joined with the first side of the can, wherein the reinforcing plate includes a second injection hole corresponding to the first injection hole and a second terminal hole corresponding to the first terminal hole; and
a cover configured to seal a second side of the can.

13. The secondary battery as claimed in claim 12, wherein the reinforcing plate comprises:
a first reinforcing plate joined with an outer surface of the can; and
a second reinforcing plate joined with an inner surface of the can.

14. The secondary battery as claimed in claim 12, further comprising an injection pin joined with the can via the first injection hole and the second injection hole, wherein the injection pin seals the first injection hole and the second injection hole.

15. The secondary battery as claimed in claim 12, further comprising an electrode terminal electrically coupled to one of the first electrode or the second electrode, and joined with the can via the first terminal hole and the second terminal hole.

16. A method for manufacturing a secondary battery comprising:
preparing a can comprising a receiving part which accommodates an electrode assembly and a flange part surrounding an opened first side of the receiving part;
joining a reinforcing plate with a first side of the receiving part;
forming a first injection hole and a second injection hole by punching the receiving part with which the reinforcing plate is joined;
forming a first terminal hole and a second terminal hole by punching the receiving part with which the reinforcing plate is joined; and
joining a cover with the flange part.

17. The method as claimed in claim 16, wherein the joining of the reinforcing plate with the first side of the receiving part comprises joining the reinforcing plate with an outer surface of the first side of the receiving part.

18. The method as claimed in claim 16, wherein the joining of the reinforcing plate with the first side of the receiving part comprises joining the reinforcing plate with an inner surface of the first side of the receiving part.

19. The method as claimed in claim 16, wherein the joining of the reinforcing plate with the first side of the receiving part comprises joining a first reinforcing plate and a second reinforcing plate with an inner surface and an outer surface of the first side of the receiving part, respectively.

20. The method as claimed in claim 16 further comprising:
after the joining of the cover with the flange part, injecting an electrolyte into an inner space of the can by inserting an electrolyte injector into the first injection hole and the second injection hole.
